(19) United States
(12) Patent Application Publication
(10) Pub. No.: US 2024/0211995 A1
(43) Pub. Date: Jun. 27, 2024

(54) SYSTEMS AND METHODS FOR EVENT RECOMMENDATION

(71) Applicant: Zoom Video Communications, Inc., San Jose, CA (US)

(72) Inventors: Chih-Chao Chen, San Jose, CA (US); Wan Chen, San Jose, CA (US); Wei Dai, Hangzhou (CN); Senlin Feng, Hangzhou (CN); Haifeng Geng, San Jose, CA (US); Tao Huang, Hangzhou (CN); Zhibin Mao, Hangzhou (CN); Xiaoli Song, San Jose, CA (US); Mengxiao Qian, San Jose, CA (US); Yang Sun, Hangzhou (CN); Melinda Min Xiao-Devins, San Jose, CA (US); Qiaojie Yang, Hangzhou (CN); Fangyi Zhao, San Jose, CA (US); Huilian Zhao, Hangzhou (CN); Xiaotian Zhou, Hangzhou (CN)

(21) Appl. No.: 17/802,120

(22) PCT Filed: Apr. 14, 2021
(86) PCT No.: PCT/CN2021/087316

§ 371 Date: Oct. 20, 2022

(51) Int. Cl. G06Q 30/0251

(52) U.S. Cl. CPC G06Q 30/0254; G06Q 30/0255

(57) ABSTRACT

One example system event recommendation includes a processor and at least one memory device. The memory device includes instructions that are executable by the processor to cause the processor to receive a plurality of user features associated with a user, receive a plurality of event features, each of said event features associated with one or more events, and determine a predicted favorite score personalized for each user for each of the one or more events, the predicted favorite score based at least in part on the plurality of user features and the plurality of event features. The memory device also includes instructions that cause the processor to display at least one of the one or more events to the user based at least in part on the personalized predicted favorite score associated with each of the one or more events.

### FIELD

The present application generally relates to video events and more particularly relates to systems and methods for event recommendation.

### BACKGROUND

Providers of in-person events sometimes desire a mechanism for providing services when in-person events are impractical. For example, event organizers may wish to create, host, and monetize events like fitness classes, concerts, stand-up or improv shows, and music lessons virtually using an online event provider. Such events may include one-time events, an event series, or drop-ins. The online event provider may allow the creator to list and sell tickets as well as share and promote public events via messaging and social media application. Such online event provider platforms allow creators to reach new audiences beyond a particular geographical location as well as cope with unforeseen disruption of in-person event hosting.

### SUMMARY

Various examples are described for systems and methods for recommending events to users. One example system includes a processor and at least one memory device. The memory device includes instructions that are executable by the processor to cause the processor to receive a plurality of user features associated with a user, receive a plurality of event features, each of said event features associated with one or more events for the user, and determine a predicted favorite score personalized for each user for each of the one or more events, the predicted favorite score based at least in part on the plurality of user features and the plurality of event features. The memory device also includes instructions that cause the processor to display at least one of the one or more events to the user based at least in part on the personalized predicted favorite score associated with each of the one or more events.

One example method includes receiving a plurality of user features associated with a user, receiving a plurality of event features, each of said event features associated with one or more events, determining a predicted favorite score for each of the one or more events, the predicted favorite score personalized for each user based at least in part on the plurality of user features and the plurality of event features, and displaying at least one of the one or more events to the user based at least in part on the personalized predicted favorite score associated with each of the one or more events.

One example non-transitory computer-readable medium includes code that is executable by a processor for causing the processor to receive a plurality of user features associated with a user, receive a plurality of event features, each of said event features associated with one or more events, and determine a predicted favorite score personalized for each user for each of the one or more events, the predicted favorite score based at least in part on the plurality of user features and the plurality of event features. The non-transitory computer-readable medium also includes instructions that cause the processor to display at least one of the one or more events to the user based at least in part on the personalized predicted favorite score associated with each of the one or more events.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1 and 2 illustrate example systems to enable an event recommendation;

FIG. 3 illustrates an example method for providing an event recommendation;

FIG. 4 illustrates an example method for providing an event recommendation;

FIG. 5 illustrates an example system for providing an event recommendation using a machine learning model;

FIG. 6 illustrates an example method for providing an event recommendation using a machine learning model; and

FIG. 7 shows an example computing device suitable for use with any disclosed systems or methods according to this disclosure.

### DETAILED DESCRIPTION

Examples are described herein in the context of systems and methods for event recommendation. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video event systems allow their users to create, host, promote, and monetize events. For example, a host may wish to create an on-going exercise class for which she charges a subscription fee. Then users who subscribe to the event can participate virtually in the exercise class.

Users may search for particular types of events or may be presented with a list of events from which to choose, such as the on-going exercise class offered by the host. In one example system, the list of events from which to choose is created based on a combination of event features and user features, such as “exercise,” “yoga,” etc. And the list is sorted based on a predicted favorite score of each event for that particular user.

For example, an event provider system may process events to identify text and non-text event features. Examples of text event features might include the title or description of the event. Examples of non-text features might include features, such as the scheduled time or duration of an event, the host of an event, or price of an event. The example system can then compile a list (or lists) of events based on the similarities of the events to one another. For example, events that all include the word “yoga” in the title may be related.

An example system may also store information related to a user's past interactions with various events. For instance, the example system may store a list of events for which the user has purchased tickets, liked, or written positive reviews. Each of these events is also associated with text and non-text event features. The example system can use this stored information to construct a list of the user's favorite events.

The example system can then use the user's historical favorite event list in combination with the list or lists of similar events stored in the system to generate a predicted favorite score for one or more events for the user. The predicted favorite score is a measure indicating the likelihood that the event is one with which the user will interact. The example system then provides the user with a list of events based on the predicted favorite score; those events with the highest score are presented first and additional events are displayed in descending order.

Such video event systems provide numerous advantages. For example, example systems provide lists of events to users that may be more likely to interest the user and thus result in increased user engagement. For some events, the user may not have been made aware of the event absent the example system. Thus, such systems may increase user satisfaction with the system. Further, since some events may be monetized, by increasing the engagement of the user, the system may consequently increase the revenue generated by the event.

This illustrative example is given to introduce the reader to the general subject matter discussed herein and the disclosure is not limited to this example. The following sections describe various additional non-limiting examples and examples of systems and methods for event recommendation.

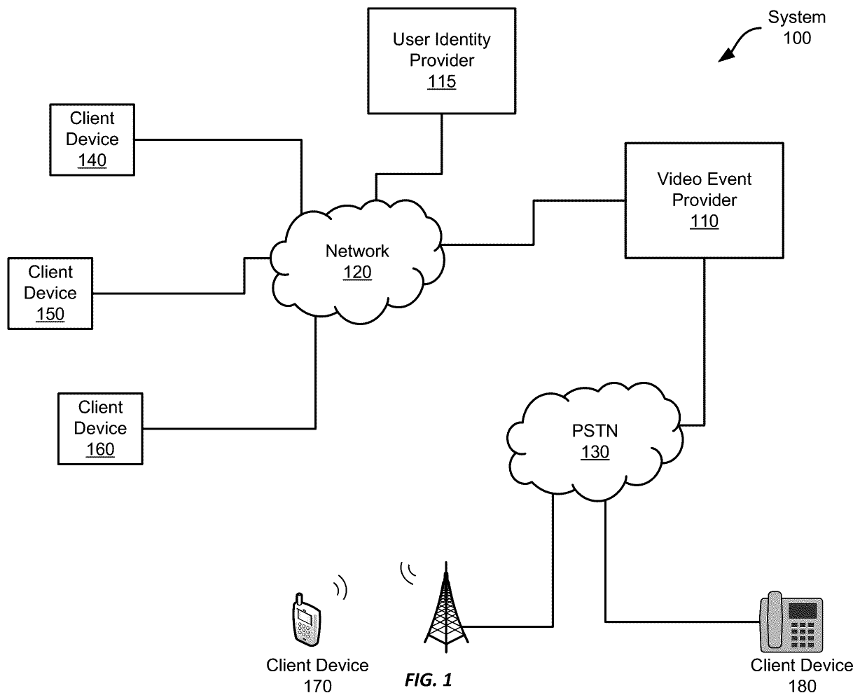

Referring now to FIG. 1, FIG. 1 shows an example system 100 that provides video conferencing functionality to various client devices. The system 100 includes a video event provider 110 that is connected to multiple communication networks 120, 130, through which various client devices 140-180 can participate in video events hosted by the video event provider 110. For example, the video event provider 110 can be located within a private network to provide video conferencing services to devices within the private network, or it can be connected to a public network, e.g., the internet, so it may be accessed by anyone. Some examples may even provide a hybrid model in which a video event provider 110 may supply components to enable a private organization to host private internal video events or to connect its system to the video event provider 110 over a public network.

The system optionally also includes one or more user identity providers, e.g., user identity provider 115, which can provide user identity services to users of the client devices 140-160 and may authenticate user identities of one or more users to the video event provider 110. In this example, the user identity provider 115 is operated by a different entity than the video event provider 110, though in some examples, they may be the same entity.

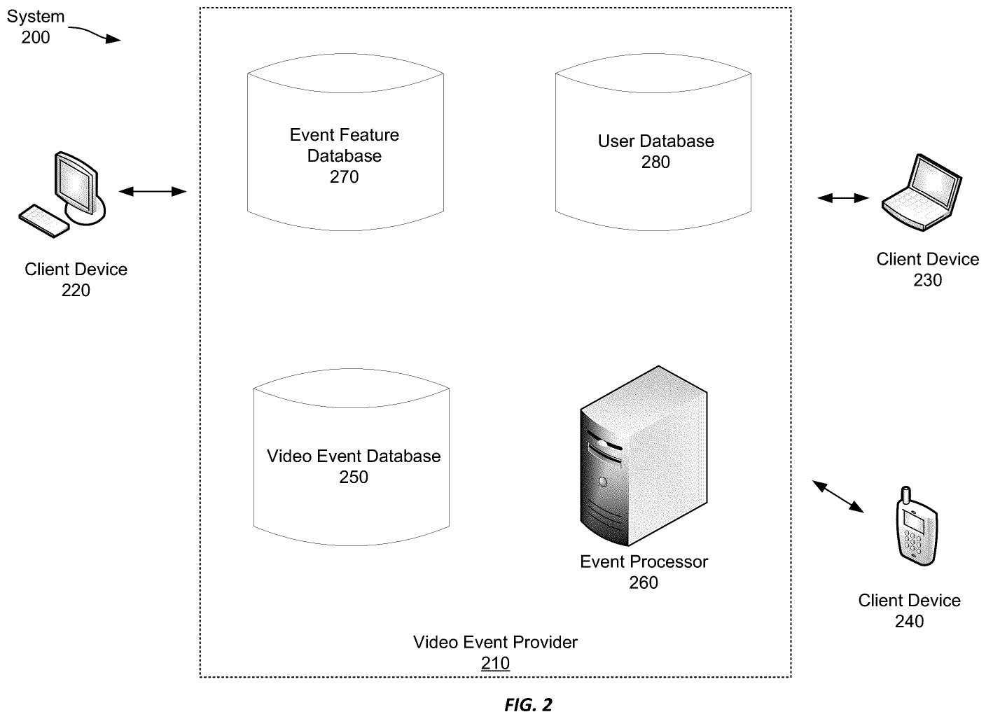

Video event provider 110 allows clients to create video events (or “events”), such as online classes, concerts and shows, and invite others to participate in those events as well as perform other related functionality, such as recording the events, generating transcripts from event audio, manage user functionality in the events, enable text messaging during the events, etc. FIG. 2, described below, provides a more detailed description of the architecture and functionality of the video event provider 110.

To create an event with the video event provider 110, an even host may contact the video event provider 110 using a client device 140-180 and select an option to create a new event. Such an option may be provided in a webpage accessed by a client device 140-160 or client application executed by a client device 140-160. For telephony devices, the host may be presented with an audio menu that they may navigate by pressing numeric buttons on their telephony device. To create the event, the video event provider 110 may prompt the host for certain information, such as a date, time, and duration for the event, a number of participants, whether the event is confidential or open to the public, etc. After receiving the various event settings, the video event provider may create a record for the event and generate an event identifier and, in some examples, a corresponding event password or passcode (or other authentication information), all of which event information is provided to the event host.

After receiving the event information, the host may distribute the event information to one or more users to invite them to the event. To begin the event at the scheduled time (or immediately, if the event was set for an immediate start), the host provides the event identifier and, if applicable, corresponding authentication information (e.g., a password or passcode). The video event system then initiates the event and may admit users to the event. Depending on the options set for the event, the users may be admitted immediately upon providing the appropriate event identifier (and authentication information, as appropriate), even if the host has not yet arrived, or the users may be presented with information indicating the that event has not yet started or the host may be required to specifically admit one or more of the users.

During the event, the participants may employ their client devices 140-180 to capture audio or video information and stream that information to the video event provider 110. They also receive audio or video information from the video event provider 210, which is displayed by the respective client device 140 to enable the various users to participate in the event.

At the end of the event, the host may select an option to terminate the event, or it may terminate automatically at a scheduled end time or after a predetermined duration. When the event terminates, the various participants are disconnected from the event and they will no longer receive audio or video streams for the event (and will stop transmitting audio or video streams). The video event provider 110 may also invalidate the event information, such as the event identifier or password/passcode.

To provide such functionality, one or more client devices 140-180 may communicate with the video event provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video event provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in an event hosted by the video event provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video event provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video event provider 110 using network 120 and may provide information to the video event provider 110 to access functionality provided by the video event provider 110, such as access to create new events or join existing events. To do so, the client devices 140-160 may provide user identification information, event identifiers, event passwords or passcodes, etc. In examples that employ a user identity provider 115, a client device, e.g., client devices 140-160, may operate in conjunction with a user identity provider 115 to provide user identification information or other user information to the video event provider 110.

A user identity provider 115 may be any entity trusted by the video event provider 110 that can help identify a user to the video event provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video event provider 110.

When the user accesses the video event provider 110 using a client device, the video event provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video event provider 110 either provides or denies access to its services, respectively.

For telephony devices, e.g., client devices 170-180, the user may place a telephone call to the video event provider 110 to access video event services. After the call is answered, the user may provide information regarding an event, e.g., an event identifier (“ID”), a passcode or password, etc., to allow the telephony device to join the event and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video event provider 110. For example, telephony devices may be unable to provide user identification information to identify the telephony device or the user to the video event provider 110. Thus, the video event provider 110 may provide more limited functionality to such telephony devices. For example, the user may be permitted to join an event after providing event information, e.g., an event identifier and passcode, but they may be identified only as an anonymous participant in the event. This may restrict their ability to interact with the events in some examples, such as by limiting their ability to speak in the event, hear or view certain content shared during the event, or access other event functionality, such as joining breakout rooms or engaging in text chat with other participants in the event.

It should be appreciated that users may choose to participate in events anonymously and decline to provide user identification information to the video event provider 110, even in cases where the user has an authenticated identity and employs a client device capable of identifying the user to the video event provider 110. The video event provider 110 may determine whether to allow such anonymous users to use services provided by the video event provider 110. Anonymous users, regardless of the reason for anonymity, may be restricted as discussed above with respect to users employing telephony devices, and in some cases may be prevented from accessing certain events or other services, or may be entirely prevented from accessing the video event provider.

Referring again to video event provider 110, in some examples, it may allow client devices 140-160 to encrypt their respective video and audio streams to help improve privacy in their events. Encryption may be provided between the client devices 140-160 and the video event provider 110 or it may be provided in an end-to-end configuration where multimedia streams transmitted by the client devices 140-160 are not decrypted until they are received by another client device 140-160 participating in the event. Encryption may also be provided during only a portion of a communication, for example encryption may be used for otherwise unencrypted communications that cross international borders.

Client-to-server encryption may be used to secure the communications between the client devices 140-160 and the video event provider 110, while allowing the video event provider 110 to access the decrypted multimedia streams to perform certain processing, such as recording the event for the participants or generating transcripts of the event for the participants. End-to-end encryption may be used to keep the event entirely private to the participants without any worry about a video event provider 110 having access to the substance of the event. Any suitable encryption methodology may be employed, including key-pair encryption of the streams. For example, to provide end-to-end encryption, the event host's client device may obtain public keys for each of the other client devices participating in the event and securely exchange a set of keys to encrypt and decrypt multimedia content transmitted during the event. Thus the client devices 140-160 may securely communicate with each other during the event. Further, in some examples, certain types of encryption may be limited by the types of devices participating in the event. For example, telephony devices may lack the ability to encrypt and decrypt multimedia streams. Thus, while encrypting the multimedia streams may be desirable in many instances, it is not required as it may prevent some users from participating in an event.

By using the example system shown in FIG. 1, users can create and participate in events using their respective client devices 140-180 via the video event provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video event provider 210 provides event recommendation. Users access events from the video event provider utilizing various client devices 220-240. The video event provider 210 may provide a web page displaying a collection of links to events that are available for a user to attend virtually. The video events may be displayed based on various features of the event or historical interactions with various events as described herein.

The client devices 220-240 include two conventional computing devices 220-230 and a telephony device 240. Each client device 220-240 communicates with the video event provider 210 over a communications network, such as the internet for client devices 220-240 or the PSTN for client device 240, generally as described above with respect to FIG. 1. The video event provider 210 is also in communication with one or more user identity providers 215, which can authenticate various users to the video event provider 210 generally as described above with respect to FIG. 1.

In this example, the video event provider 210 employs multiple different servers (or groups of servers) to provide different aspects of video event functionality, thereby enabling the various client devices to create and participate in video events. Each of these servers is connected to one or more communications networks to enable them to collectively provide access to and participation in one or more video event meetings to the client devices 220-240.

The video event provider includes an event processor 260. The event processor 260 is able to provide an event recommendation list for each user based on the user's historical interaction with events. The event processor 260 accesses one or more databases storing information regarding events and user's interactions with events.

The example system 200 shown includes a video event database 250. The video event database 250 includes events created by event hosts. For example, a host may create a video of an exercise class that users may subsequently purchase tickets for and attend. The video event database may include the video as well as features related to the event, including both text and non-text features. Text features may include, for example, the event title, description, the category, and a tag, which is a host-defined word or phrase. Non-text features may include, for example, the start and end date and time, the day of the week, flags indicating that the event is on a weekend or a holiday, the days remaining until the event, the host, whether the event is public or private, the price and currency, sales prices and periods, and the category of the event.

The video event provider also includes an event feature database 270. The event feature database 270 stores features extracted from the video event database 250. For example, the event feature database 270 may include a list of event identifiers and associated text and non-text features. The event feature database 270 can then be used by the event processor to determine similarities between the various events based on a comparison of the various features of each event.

The video event provider 210 also includes a user database 280. The user database 280 stores information regarding the user's historical interactions with various events. The events associated with the user in user database 280 are also associated with various event features. These user-associated event features are stored in the event feature database 270. Historical user interactions stored in the user database 280 may include various categories, such as actions and ratings. Actions include, for example, purchases, gifts, likes, clicks. Ratings may include, for example, a numerical or alphanumeric score associated by a particular user with a particular event, or a number of stars (or other icon) out of a maximum number of stars, etc. The users' actions and ratings can be used to create a recommended event list for the user. A recommended event list is a set of events displayed in a user interface. In some embodiments, if the user has not interacted with any events, then a recommended event list may be created by, for example, generating a list of popular upcoming events created by popular hosts in the video event database 250, based on, for example the event host's historical ticket sales, ratings, click numbers and other metrics.

It should be appreciated that the components of the video event provider 210 discussed above are merely examples of such devices and an example architecture. Some video event providers may provide more or less functionality than described above and may not separate functionality into different types of servers as discussed above. Instead, any suitable servers and network architectures may be used according to different examples.

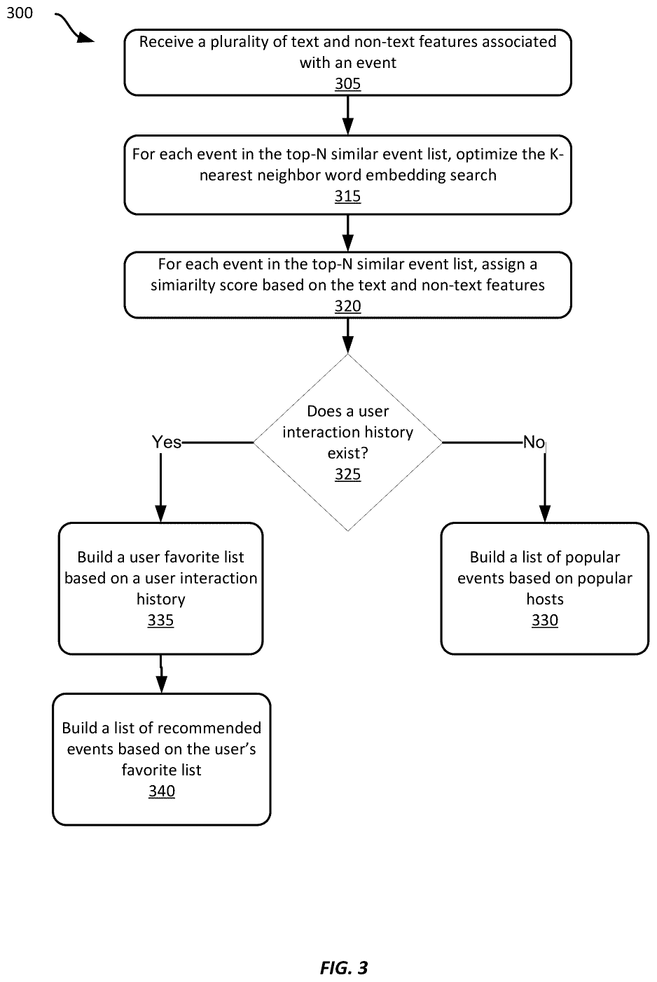

Referring now to the method 300 illustrated in FIG. 3, FIG. 3 shows an example method 300 for event recommendation. The description of the method 300 in FIG. 3 will be made with reference to the system 100 and 200 shown in FIGS. 1 and 2; however any suitable system according to this disclosure may be used, such as the example systems 100 and 200 shown in FIGS. 1 and 2.

At block 305, a processor at video event provider 210 receives a plurality of text and non-text features associated with an event. For example, the event processor 260 may access the event feature database 270 to compile a list of events and then, for each of the events, a set of features associated with the event.

Then at block 310, for each event, the event processor 260 builds a top-N similar event list based on the event's text features, where N is an integer value representing the number of similar events to identify. One method for determining the similarity of events is to utilize the Facebook AI Similarity Search (Faiss) library to optimize the K-nearest neighbor graph for embedding search. For example, the event processor 260 may assign a high similarity score to two events that each include the same words in the title. As another example, the event processor 260 may assign a medium score to two events that have titles that are associated with similar types of events, such as a first exercise-related event that includes “yoga” in the title and a second exercise-related event that includes “Pilates” in the title. The result of the processing in step 310 is an index that includes the top-N most similar events to the event processed by the event processor 260.

In block 320, for each event and its top-N similar events, the event processor 260 assigns a similarity score that is based on the text and non-text features of the event and the similar events. In one example, the event processor 260 assigns numerical weights to each text feature and each non-text feature and uses the weights to calculate a similarity. For instance, the weights may be set as 2.0 for the title, 1.0 for the category, 0.5 for the duration, 0.5 for the price, and 0.25 for the start time.

In block 325, the event processor 260 begins creating the favorite list for the user. The event processor 260 determines whether a user interaction history exists. For example, the event processor 260 may access the user database 280, searching for the user's identifier in the user database 280, which includes data indicating that a particular user has interacted, e.g., bought a ticket for a particular event. If the event processor 260 determines that the user has not interacted with any events, i.e., the user has no interaction history, then the method 300 proceeds to block 330. Otherwise, the method 300 proceeds to block 335.

At block 330, the event processor 260 may build a list of popular events based on popular hosts. Alternatively, the event processor 260 may generate a list based on criteria, such as promoted events or featured events. For instance, in one example, the event processor relies on a measure of a host's popularity to generate the list. In one such example, the host popularity is measured from three perspectives: (1) the average of all the users' favorite scores for all the events the host has hosted, (2) the number of events the host has already hosted, and (3) the average number of users for each event the host has hosted. Each of these measures can be compared to a threshold to eliminate events below the thresholds. Then the host popularity score can be calculated as the product of the three measures. The event processor 260 then identifies the most popular hosts based on the host popularity score. Then the event processor 260 identifies active events associated with the most popular N hosts, where N is an integer.

In block 335, the event processor determines that the user is associated with a user interaction history. The event processor 260 then builds a list of a user's favorite events based on the user's interaction history. The event processor 260 may build the user favorite list in various ways. For example, the event processor 260 may assign a score to a user action or to an action rating. For instance, if a user purchases an event, the event may be assigned an action score of 100, and if a user likes an event, the event may be assigned an action score of 10. In relation to a rating score, the user rating may be proportional to the rating score, e.g., a high rating would be associated with a rating score of 100 and a low rating with a score of 1. The event processor can then calculate a favorite score as the product of the action score and the rating score.

Once the event processor 260 generates the user favorite list, then at block 340 the event processor 260 generates a recommended event list to present to the user. The event list is based on a prediction of what the user may be likely to select to attend or otherwise engage with. The prediction is referred to herein as a “predicted favorite score.” The predicted favorite score may be determined through a formula. For instance, each event in the user's historical favorite event list may be assigned a numerical value based on its position within the user's historical favorite list, e.g., the higher the favorite in the user's historical favorite list, the higher the numerical value. Then, when the event processor 260 compares the user's historical favorite list to a list of potentially recommended events from the list constructed above, the similarity between the event in the user's list and the potentially-recommended event, e.g., the similarity score, is multiplied by the numerical value that was based on the position of the user's historical favorite to determine the sorting of the events recommended to the user. In other words, the events that are more similar to the user's historical favorite event(s) are placed higher in the recommended list than events that are similar to user's less historical favorite events. In other embodiments, machine learning algorithms may be utilized rather than a formulaic algorithm.

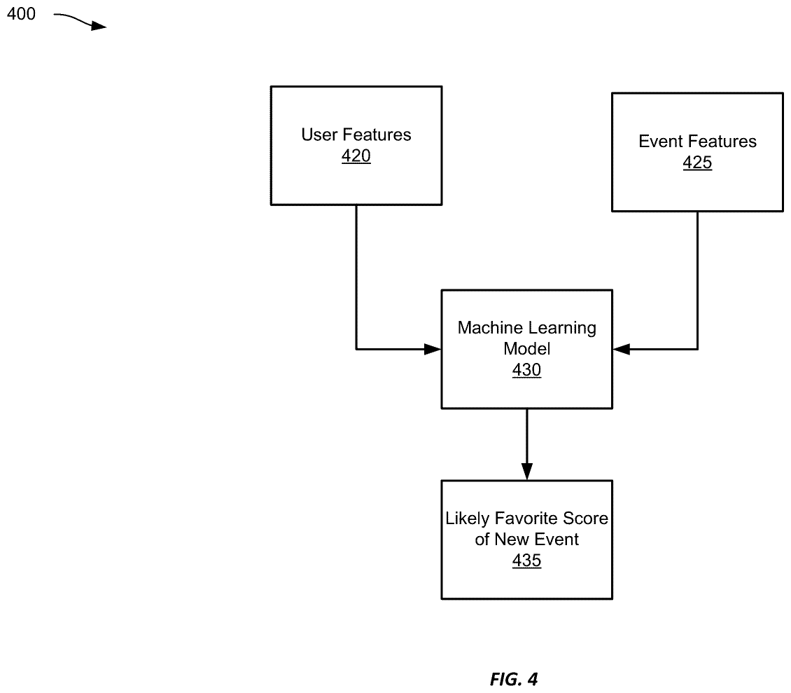

Referring now to FIG. 4, FIG. 4 shows an example machine learning (“ML”) model for event recommendation. Various types of models or artificial intelligence algorithms may be used in example systems. For example, simple machine learning models, such as Linear Regression and XGboost may be used. In other examples, more sophisticated models, such as Factorization Machines (“FM”). As more data is available in a system according to these examples, deep learning models may be utilized, such as Deep FM and Wide&Deep or other similar models. Other alternative ML models that might be used include a deep convolutional neural networks (“CNN”), a residual neural network (“Resnet”), or a recurrent neural network, e.g. long short-term memory (“LSTM”) models or gated recurrent units (“GRUs”) models. The ML model 430 can also be any other suitable ML model, such as a three-dimensional CNN (“3DCNN”), a dynamic time warping (“DTW”) technique, a hidden Markov model (“HMM”), etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with ML models, such as AEGANs or variational AEGANs (“VAEGANs”).

In the example shown in FIG. 4, user features 420 and event features 425 are provided to train a machine learning model 430. Through the training, the machine learning model 430 learns the importance (weights) of both user features 420 and event features 425 with respect to the likelihood a user will interact with an event. Once the machine learning model 430 has been trained, the machine learning model 430 can determine the likely popularity score of a new event by calculating the new event's features with the corresponding weights 435.

The machine learning model 430 is trained using a training data set. The training data set includes data from past events and users who interacted with past events. For example, user features 420 include user involvement such as ticket purchased, clicks and ratings to various events. Event features 425 include both text features, such as the event title and description, and non-text features, such as an event's ticket price, time, and duration. The machine learning model then can predict the user's favorite score to a new event. Since the model is trained using past data, the user's favorite score to a past event can be calculated using the user's number of clicks to that event, ticket purchased, favorite or not, and the user's post event rating.

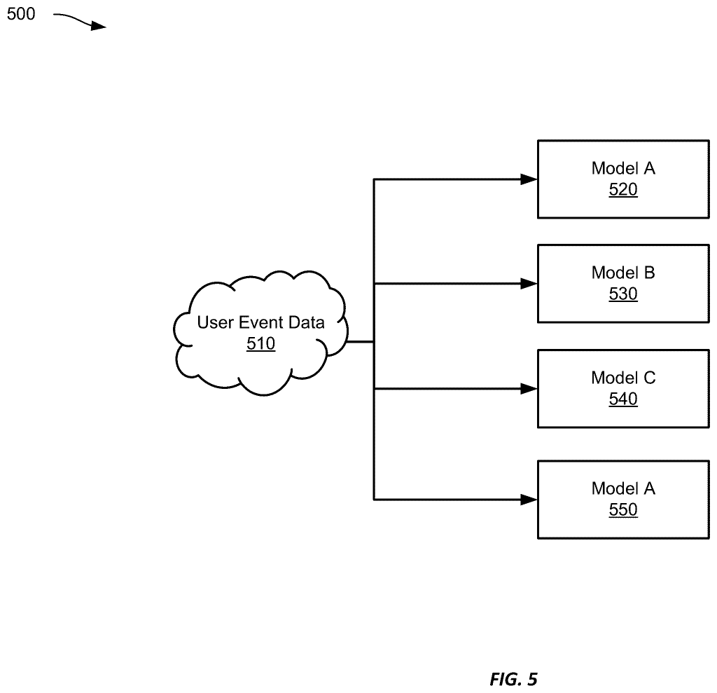

Referring now to FIG. 5, FIG. 5 is a block diagram showing a system 500 for identifying the optimal model for event recommendation using machine learning. In the system 500 shown, user event data 500 can be processed using one of four models, model A 520, model B 530, model C 540, or model D 550. In the example system, each model 520-550 is a different machine learning model and thus may provide a different result for the predicted probability score for each event.

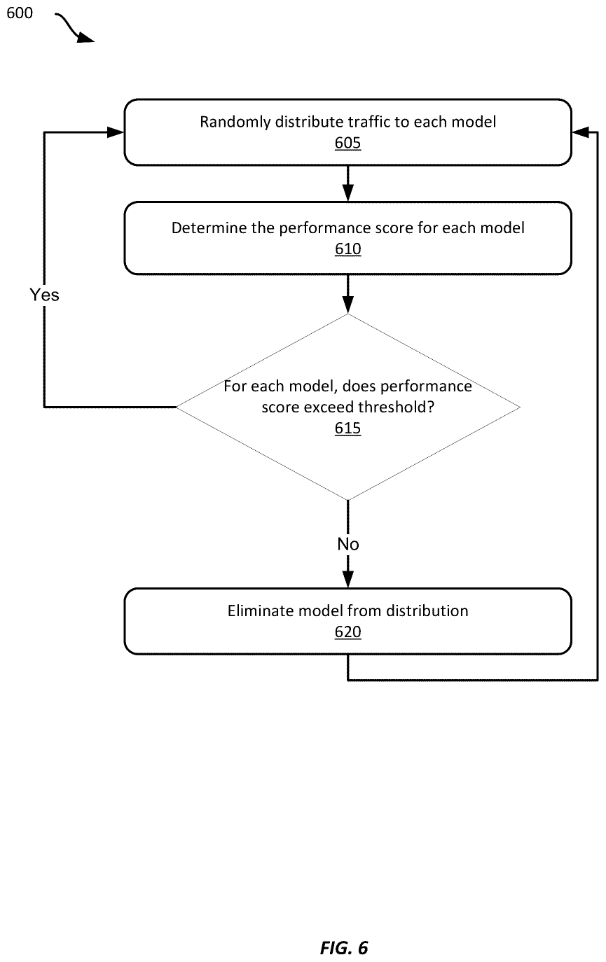

Referring now to FIG. 6, FIG. 6 illustrates an example method for providing event recommendation using a machine learning model. In the example method, the system 500 identifies the optimal model to use by distributing data and then determining the accuracy of the individual model. The accuracy of a model, also referred to as the model's performance matrix, can be measured in a variety of ways, such as by monitoring the click-through rate or conversion rate of the resulting events. The better performing model can then be set to receive higher traffic, i.e., more of the user event data 510 in the next iteration of this method. After many iterations, the models that do not perform well are phased out, while the higher performing model or models continues to process user event data 510. This method is described in relation to the system illustrated in FIG. 5. But the system of FIG. 5 is merely an example, and other numbers and combinations of models may be utilized. For example, additional or fewer numbers of different models may be used.

In the method shown in FIG. 6, four models are used 520-550. As described below, the process 600 is iterative. At the end of each iteration, a model's performance is compared to a threshold to determine whether to phase a model out. In the example method, the threshold is set based on a performance score, and the value of the threshold is 0.1. Other measures of performance and values of the threshold may be utilized in various examples. In some examples, rather than phasing a model out, the model may be replaced by another model.

In step 605, the user event data, e.g., data related to newly-created events, is randomly distributed to each model 520-550 to calculate the predicted favorite score. For example, in a first iteration, the user event data 510 may be distributed randomly but evenly to each model 220-250, i.e., 25% of the event data is processed by each model. Then the events are displayed to users in each user's user interface in the order of predicted favorite score for each event as calculated for that particular user. In other words, the first event displayed to the user is the event that the particular model predicted would be most popular for that user. And the second displayed event would be the event predicted to be the second most popular.

At step 610, the example method tracks various users' interactions with the events displayed in each user's user interface to determine the model's performance score. In the example method shown, each event's click-through rate (or conversion rate) is tracked and then used to evaluate the model's performance. Other measures may be utilized, such as a user suggesting the event to a friend. In one example method, the performance score is normalized to a number between 0 and 1, and the sum of the performance measure across the four models 220-250 equals 1. For example, the performance score for model A 220 might equal 0.15, for model B 230 equal 0.2, for model C equal 0.5, and for model D 250 equal 0.15.

At step 615, the model's performance score is compared to a threshold. In the example system the threshold is set to 0.1. The threshold may be determined based on experience with past performance of various machine learning models. Further, the performance measure may be varied based on the type of user event data 500. For instance, some types of user event data may result in more variance between machine learning models and thus a higher threshold for phasing out a particular model may be appropriate. If the performance score for the particular model exceeds the threshold, then the model will be utilized in the next iteration of the method 600. If not, then at step 620, the model where the performance score is below the threshold is phased out of the example system 500 prior to the next iteration. In other examples, the lowest performing model is phased out without reference to a threshold.

During the subsequent interaction of the method 600, user event data 500 is again randomly distributed to each model at step 605, however the distribution is based on a ratio that is proportional to the model performance score from the first interaction of the method 600. For instance, in the example method, model A receives 15% of the traffic during this second iteration because its performance score from the first iteration was calculated as 0.15. Model B receives 20% traffic because its performance score was 0.2. Then the process 600 continues for this second iteration. In the second iteration, model A's performance score is calculated and normalized as 0.05 in step 610. Thus for subsequent iterations, model A 520 is phased out at step 620 and the process 600 iterates again. The process continues to iterate until all but a single model 220-250 remains. At that point, the optimal model for that particular set of user event data 500 has been identified, and process 600 ends. In some embodiment, a model may be retrained or updated as additional data is created in the system.

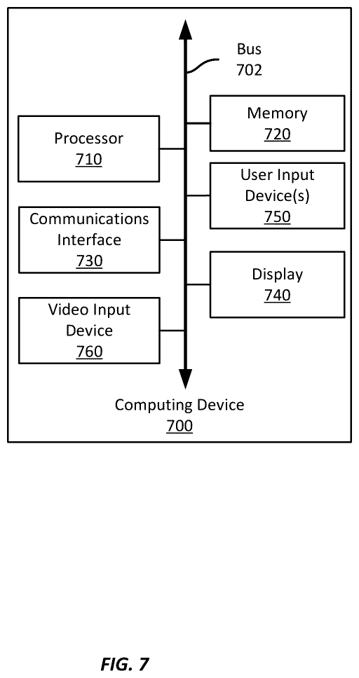

Referring now to FIG. 7, FIG. 7 shows an example computing device 700 suitable for use in example systems or methods for sharing content across video conferencing sub-meetings. The example computing device 700 includes a processor 710 which is in communication with the memory 720 and other components of the computing device 700 using one or more communications buses 702. The processor 710 is configured to execute processor-executable instructions stored in the memory 720 to perform one or more methods for providing waiting notifications and managing a waiting queue according to different examples, such as part or all of the example method 500 described above with respect to FIG. 5. The computing device, in this example, also includes one or more user input devices 750, such as a keyboard, mouse, touchscreen, video input device (e.g., one or more cameras), microphone, etc., to accept user input. The computing device 700 also includes a display 740 to provide visual output to a user as well as a video input device 770, such as a camera, to capture visual input.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving a plurality of user features associated with a user;
receiving a plurality of event features, each of said event features associated with one or more events;
determining a predicted favorite score for each of the one or more events personalized for each user, the predicted favorite score based at least in part on the plurality of user features and the plurality of event features; and
displaying at least one of the one or more events to the user based at least in part on the personalized predicted favorite score associated with each of the one or more events.

2. The method of claim 1, wherein the plurality of user features comprises a measure of user involvement associated with a past event.

3. The method of claim 2, wherein the measure of user involvement with the past event comprises at least one of a purchase, a selection, or a rating.

4. The method of claim 2, wherein the predicted favorite score is determined based on at least one of a plurality of machine learning models based on the measure of user involvement.

5. The method of claim 4, wherein the measure of user involvement comprises a plurality of measures of user involvement and further comprising:
evenly and randomly distributing each of the plurality of measures of user involvement between the plurality of machine learning models;
receiving additional measures of user involvement; and
evaluating a performance of each of the plurality of machine learning models based on the additional measures of user involvement.

6. The method of claim 5, further comprising selecting an optimal machine learning model of the plurality of machine learning models based on the evaluation of the performance of each of the plurality of machine learning models.

7. The method of claim 1, wherein the event features comprise at least one of a text feature and a non-text feature.

8. A system comprising:
a processor; and
at least one memory device including instructions that are executable by the processor to cause the processor to:
receive a plurality of user features associated with a user;
receive a plurality of event features, each of said event features associated with one or more events;
determine a predicted favorite score personalized for each user for each of the one or more events, the predicted favorite score based at least in part on the plurality of user features and the plurality of event features; and
display at least one of the one or more events to the user based at least in part on the personalized predicted favorite score associated with each of the one or more events.

9. The system of claim 8, wherein the plurality of user features comprises a measure of user involvement associated with a past event.

10. The system of claim 9, wherein the measure of user involvement with the past event comprises at least one of a purchase, a selection, or a rating.

11. The system of claim 9, wherein the predicted favorite score is determined based on at least one of a plurality of machine learning models based on the measure of user involvement.

12. The system of claim 11, wherein the measure of user involvement comprises a plurality of measures of user involvement and further comprising instructions that are executable by the processor to cause the processor to:
evenly and randomly distribute each of the plurality of measures of user involvement between the plurality of machine learning models;
receive additional measures of user involvement; and
evaluate a performance of each of the plurality of machine learning models based on the additional measures of user involvement.

13. The system of claim 12, further comprising instructions that are executable by the processor to cause the processor to select an optimal machine learning model of the plurality of machine learning models based on the evaluation of the performance of each of the plurality of machine learning models.

14. The system of claim 8, wherein the event features comprise at least one of a text feature and a non-text feature.

15. A non-transitory computer-readable medium comprising code that is executable by a processor for causing the processor to:
receive a plurality of user features associated with a user;
receive a plurality of event features, each of said event features associated with one or more events;
determine a predicted favorite score personalized for each user for each of the one or more events, the predicted favorite score based at least in part on the plurality of user features and the plurality of event features; and
display at least one of the one or more events to the user based at least in part on the personalized predicted favorite score associated with each of the one or more events.

16. The non-transitory computer-readable medium of claim 15, wherein the plurality of user features comprises a measure of user involvement associated with a past event.

17. The non-transitory computer-readable medium of claim 16, wherein the measure of user involvement with the past event comprises at least one of a purchase, a selection, or a rating.

18. The non-transitory computer-readable medium of claim 16, wherein the predicted favorite score is determined based on at least one of a plurality of machine learning models based on the measure of user involvement.

19. The non-transitory computer-readable medium of claim 18, wherein the measure of user involvement comprises a plurality of measures of user involvement and further comprising instructions that are executable by the processor to cause the processor to:
evenly and randomly distribute each of the plurality of measures of user involvement between the plurality of machine learning models;
receive additional measures of user involvement; and
evaluate a performance of each of the plurality of machine learning models based on the additional measures of user involvement.

20. The non-transitory computer-readable medium of claim 18, further comprising instructions that are executable by the processor to cause the processor to select an optimal machine learning model of the plurality of machine learning models based on the evaluation of the performance of each of the plurality of machine learning models.
